(19) United States
(12) Patent Application Publication
(10) Pub. No.: US 2009/0288033 A1
(43) Pub. Date: Nov. 19, 2009

(54) User-Directed Capture of Unstructured Information from Web Pages with Assignment to Data Type

(75) Inventors: David Thomas Van Valkenburgh, Elk Ridge, UT (US); Robert Duffin Wilson, Pleasant Grove, UT (US); Gary K. Jestice, Pleasant Grove, UT (US); Mark Anthoni Lemonnier, Provo, UT (US); Kevin Niels Christiansen, Orem, UT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Generations Network, Inc., Provo, UT (US)

(21) Appl. No.: 12/121,664

(22) Filed: May 15, 2008

(51) Int. Cl. G06F 3/048

(52) U.S. Cl. 715/777; 715/781; 715/810

(57) ABSTRACT

A software application includes a window having at least first and second panels. The first panel is programmed to provide access to Internet-based sources of information. The software application also includes a user-operable selection tool programmed to select non-structured information from an Internet-based source of information presented in the first panel. The software application also includes a menu responsive to the selection tool that is programmed to appear upon the selection of non-structured information, display a plurality of data types to which the selected non-structured information can be assigned, and receive a user-selection of one of the plurality of data types to which the selected non-structured information is to be assigned. The second panel is programmed to, upon selection of one of the plurality of data types, display the selected non-structured data and indicate to which of the plurality of data types the selected information was assigned.

### FIELD OF THE INVENTION

Embodiments of the present invention relate generally to personal productivity applications. More specifically, embodiments of the invention relate to systems and methods for capturing unstructured information from electronic sources and assigning the captured information to a data type of a personal productivity application.

### BACKGROUND OF THE INVENTION

The Internet provides access to a wealth of information. It acts as a repository of data for anyone desiring to publish information. Given the volume of information available and the sheer numbers of individuals publishing this data, there exists no single framework within which the information may be categorized.

Individuals frequently desire to acquire information from Internet-based sources for use in personal-productivity applications. Because data used in such applications frequently must be assigned to a particular data type, the process can be inefficient. Hence, improvements are desired.

### BRIEF SUMMARY OF THE INVENTION

Embodiments of the present invention provide a software application. The software application includes a window having at least first and second panels. The first panel is programmed to provide access to Internet-based sources of information. The software application also includes a user-operable selection tool programmed to select non-structured information from an Internet-based source of information presented in the first panel. The software application also includes a menu responsive to the selection tool that is programmed to appear upon the selection of non-structured information, display a plurality of data types to which the selected non-structured information can be assigned, and receive a user-selection of one of the plurality of data types to which the selected non-structured information is to be assigned. The second panel is programmed to, upon selection of one of the plurality of data types, display the selected non-structured data and indicate to which of the plurality of data types the selected information was assigned.

In some embodiments, the software application includes a plurality of user-selectable data category tabs operable to determine the plurality of data types. The software application may be a genealogy investigation application. One of the plurality of data category tabs may be a facts tab, and the plurality of data types may include name, birth date, birth place, death date, death place, burial date, burial place, marriage date, marriage place, spouse's name, mother's name, father's name, and child's name. One of the plurality of data category tabs may be a notes tab. One of the plurality of data category tabs may be a media tab. One of the data types may be a date data type, and the application may be programmed to parse the selected non-structured information into a month, a day, and a year.

In some embodiments a computer-readable medium has stored thereon computer-executable instructions for capturing unstructured information from an electronic source for incorporation into a project as a particular data type. The instructions include instructions for displaying information from an electronic source, receiving a user's selection of at least a portion of the information, in response to the user's selection, displaying a menu of data types to which the information may be assigned, receiving a user's selection of a data type, and displaying the selected non-structured information and an indicator indicating to which of the plurality of data types the selected information was assigned.

In some embodiments, the instructions include instructions for providing a plurality of user-selectable data category tabs operable to determine the data types. The instructions may be a genealogy investigation application. The plurality of data category tabs may include a facts tab. The data types may include name, birth date, birth place, death date, death place, burial date, burial place, marriage date, marriage place, spouse's name, mother's name, father's name, and child's name. One of the plurality of data category tabs may be a notes tab. One of the plurality of data category tabs may be a media tab. One of the data types may be a date data type and the instructions may include instructions for parsing the selected non-structured information into a month, a day, and a year.

In still other embodiments, a method of capturing unstructured information from an electronic source for incorporation into a project as a particular data type includes displaying information from an electronic source, receiving a user's selection of at least a portion of the information, in response to the user's selection, displaying a menu of data types to which the information may be assigned, receiving a user's selection of a data type, and displaying the selected non-structured information and an indicator indicating to which of the plurality of data types the selected information was assigned.

In some embodiments the method includes providing a plurality of user-selectable data category tabs operable to determine the data types. One of the plurality of data category tabs may be a facts tab, and the data types may include one or more selections from a group consisting of name, birth date, birth place, death date, death place, burial date, burial place, marriage date, marriage place, spouse's name, mother's name, father's name, and child's name. One of the plurality of data category tabs may be a notes tab. One of the plurality of data category tabs may be a media tab. One of the data types may be a date data type and the method may include parsing the selected non-structured information into a month, a day, and a year.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a schematic illustration of a physical structure of a computer system that may be used to implement embodiments of the invention.

FIG. 1B shows a schematic illustration of a computer network that may be used to implement embodiments of the invention.

FIG. 2 is a flowchart of a method for capturing unstructured information from electronic sources according to embodiments of the invention.

FIGS. 3A to 3E are screen shots depicting various operations of the method of FIG. 2 as implemented on a computer system such as depicted in FIG. 1.

### DETAILED DESCRIPTION OF THE INVENTION

Embodiments of the present invention relate to capturing unstructured information from electronic resources. In order to provide a context for describing embodiments of the present invention, embodiments of the invention will be described herein with reference to genealogy investigation applications that acquire information from Internet-based sources, such as web pages. Those skilled in the art will appreciate, however, that other embodiments are possible.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Embodiments of the present invention relate to capturing unstructured data from Internet-based resources and assigning the information to a data type of a personal productivity application operating on the user's machine. In some embodiments, the information may be edited before or after assignment. The information may be alphanumeric, image, or the like. In specific embodiments, the personal productivity application is a genealogy research application such as Family Tree Maker by Ancestry.com of Provo, Utah.

According to embodiments of the invention, the user accesses a web site within a window of the application. The user selects information to be acquired from the web site. Upon selection of the information, the application displays a menu of data types to which the information may be assigned. The menu may have submenus.

Upon assignment of the information to a data type, the information is displayed in an edit window of the application. The user may edit the newly-assigned data before merging it into the application.

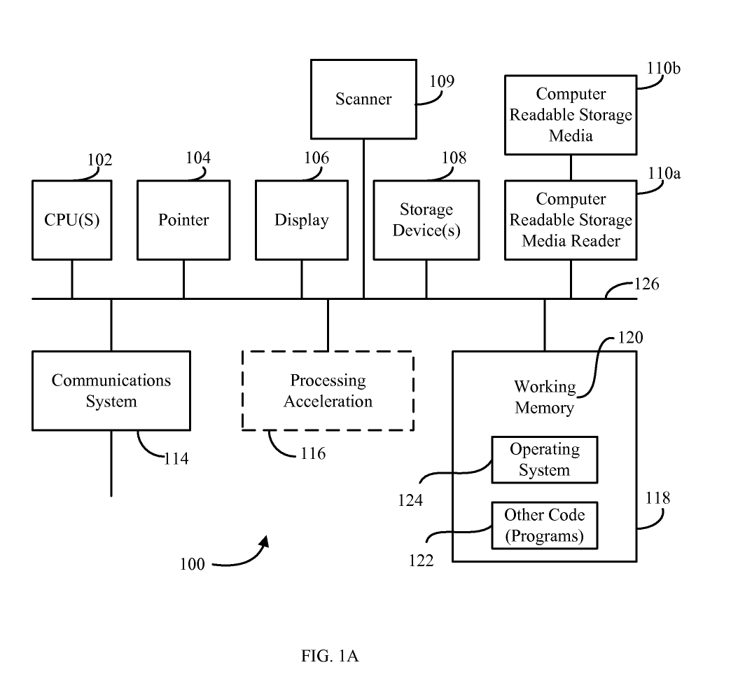

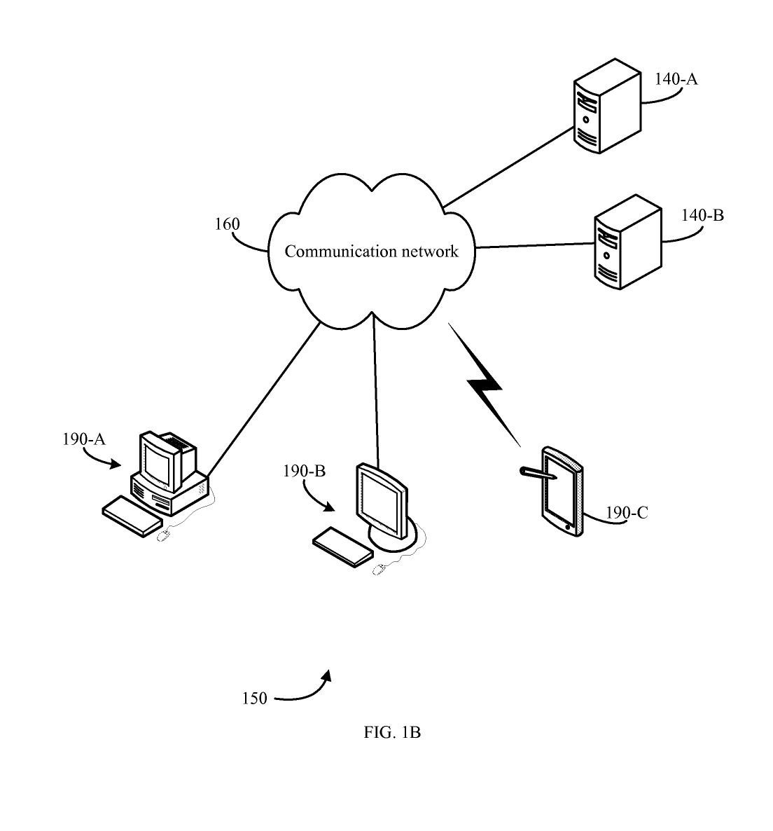

Having described embodiments of the invention generally, attention is directed to FIG. 1A. FIG. 1A shows a schematic illustration of a physical structure of a computer system 100 that may be used to implement embodiments of the invention. FIG. 1A broadly illustrates how individual system elements may be implemented in a separated or more integrated manner. The host system 100 is shown comprised of hardware elements that are electrically coupled via bus 126, including the host processor 102, an input device 104, an output device 106, a storage device 180, a scanner 109, a computer-readable storage media reader 110a, a communications system 114, a processing acceleration unit 116 such as a DSP or special-purpose processor, and a memory 118. The computer-readable storage media reader 110a may be further connected to a computer-readable storage medium 110b, the combination comprehensively representing remote, local, fixed, and/or removable storage devices plus storage media for temporarily and/or more permanently containing computer-readable information. The communications system 114 may comprise a wired, wireless, modem, and/or other type of interfacing connection and permits data to be exchanged with a communication network such as the Internet or an intranet.

The host system 100 also comprises software elements, shown as being currently located within working memory 120, including an operating system 124 and other code 122, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

FIG. 1B shows a schematic illustration of a computer network 150 that may be used to implement embodiments of the invention. The computer network includes a variety of computer systems 190. Such computer systems 190 may include the architecture shown in FIG. 1A. The computer systems may include user interfaces such as a keyboard, mouse, stylus, touch screen, display, etc. Each of the computer systems 190 may be in communication with a communication network 160 such as, for example, the Internet or an intranet. For example, computer system 190-C is wirelessly connected to the communication network 160.

The computer network 150 also includes servers 140. The servers may be, for example, web servers such as the server 140-A, or ftp servers, such as the ftp server 140-B. In essence, the servers 140 may be any device capable of hosting user-accessible information, which information may be accessed by, for example, a web browser or other application operating on one of the computer systems 190.

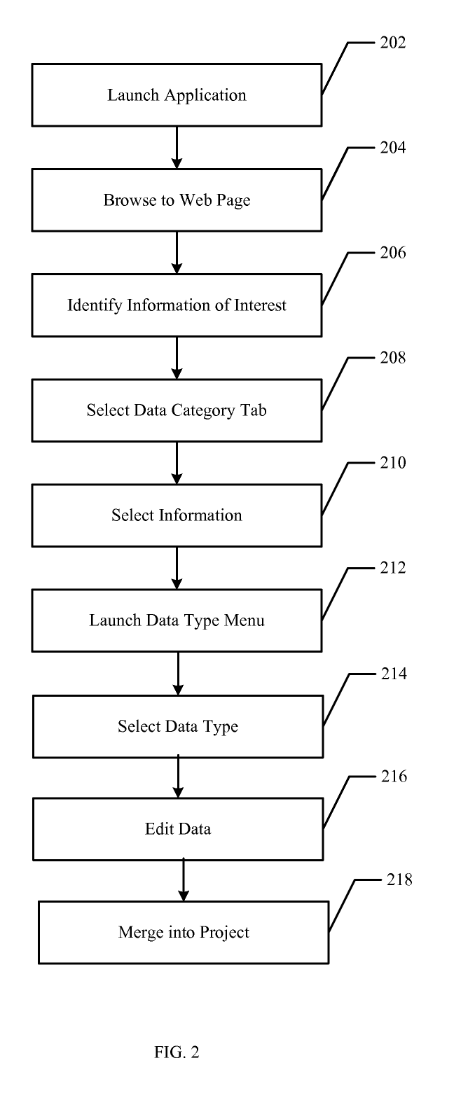

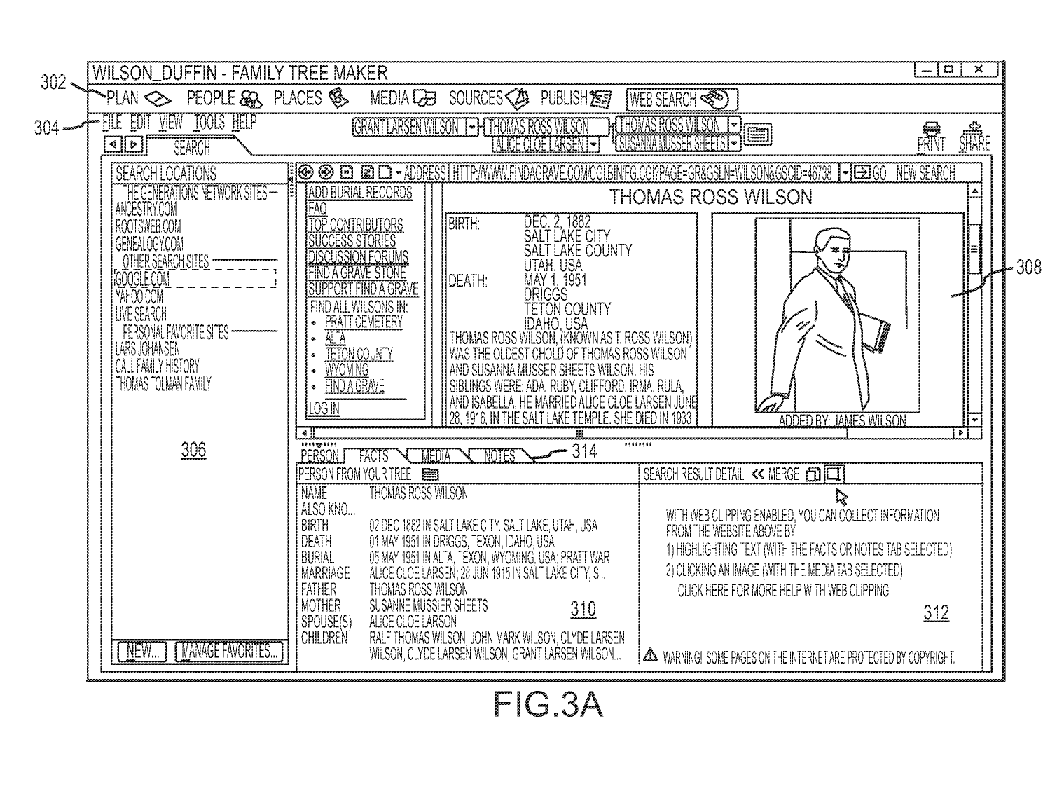

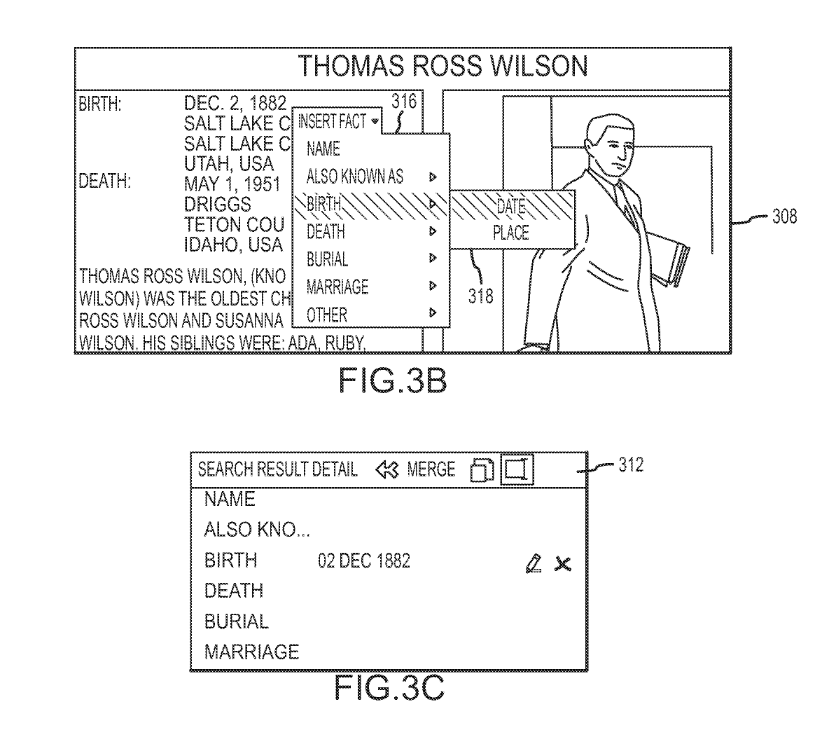

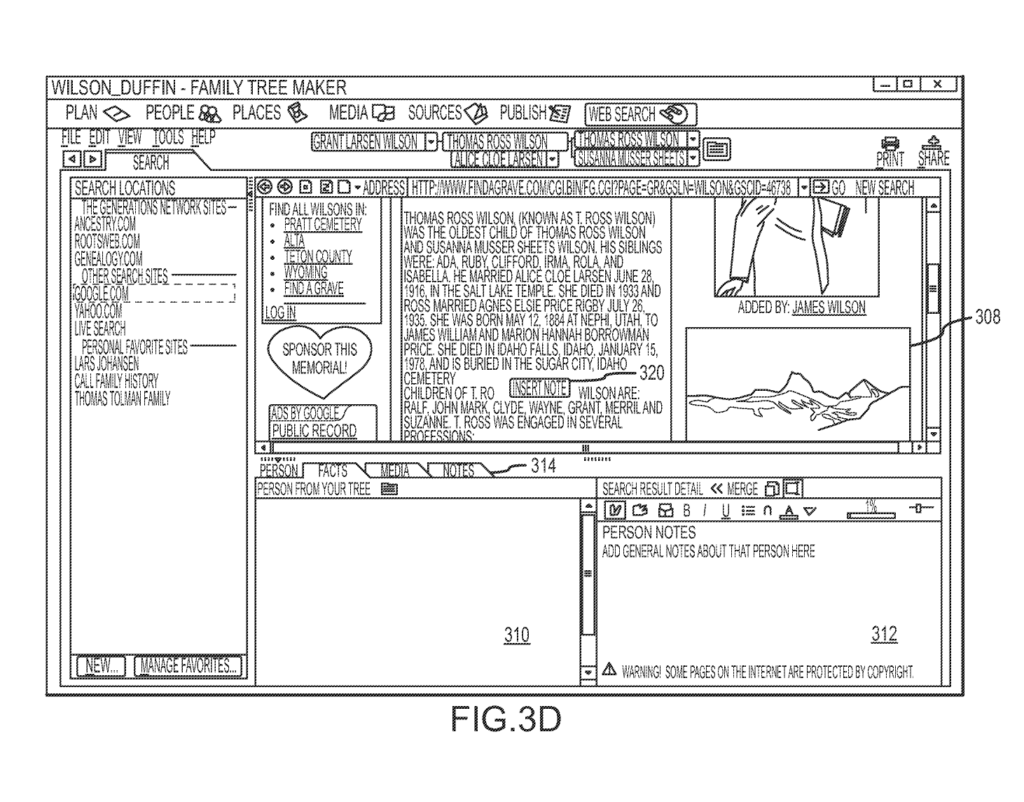

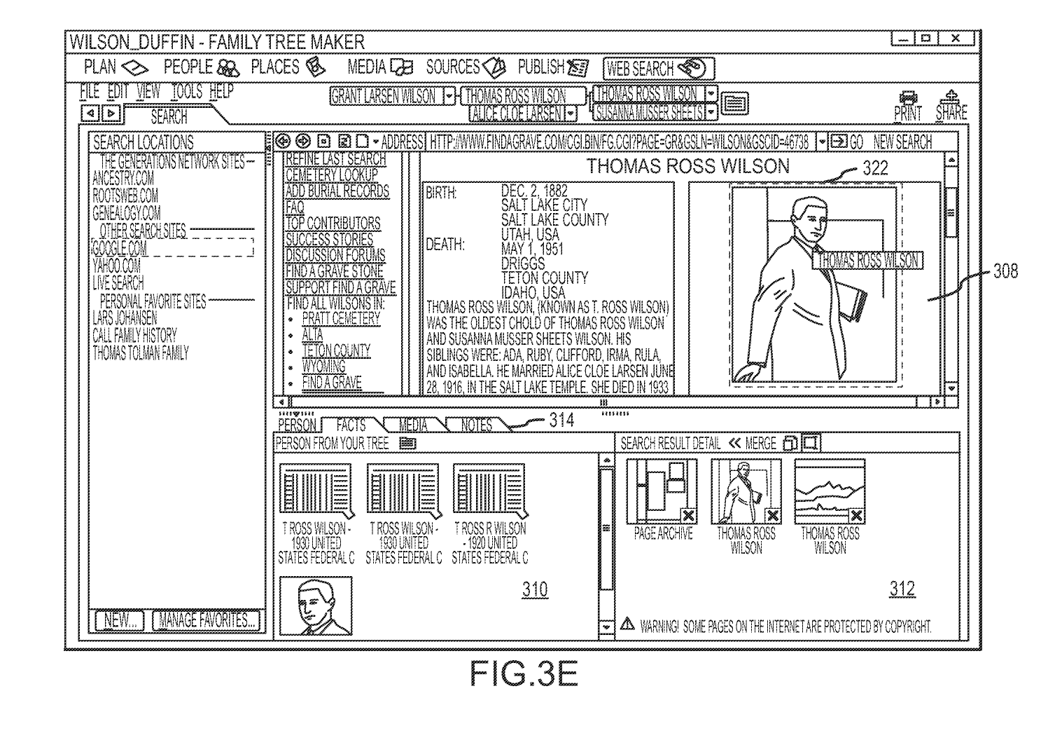

Having described exemplary hardware environments within which embodiments of the invention may be implemented, attention is directed to FIG. 2, which depicts a flowchart of a method for capturing unstructured information from electronic sources according to embodiments of the invention. Those skilled in the art will appreciate that the method of FIG. 2 is merely exemplary of a number of methods according to other embodiments. Further, other methods according to other embodiments may have more, fewer, or different blocks than those illustrated and described here. Moreover, the blocks depicted here may be traversed in orders different than described here. The method begins at block 202, upon the user launching an application on a computing device. The application may be, for example, a genealogy investigation application, such as Family Tree Maker. Upon doing so, the user may see the screen shot depicted in FIG. 3A.

FIG. 3A depicts an application window of an application that implements embodiments of the present invention. The application window includes buttons 302 and menus 304. It also includes a search window 306 that provides hyperlinks to various information sources (e.g., web sites). Additionally, the application window includes three panels: a browser panel 308, a project data panel 310, and an information editing panel 312, all of which will be described in greater detail below.

Returning to FIG. 2, at block 204 the user browses to an information source, which may be, for example, a web page. The user would do this in the browser panel 308 of the application window.

In the browser window, sources from web sites and other information sources would be displayed as if opened in the user's web browser. In a specific embodiment, all links or navigation function as intended by the creator of the web page. Frames are supported client-side scripts are supported. Plugins installed on the user's computer (i.e.—flash, java, etc.) that are available to the user's browser and that are used by a web page loaded into the application are available. Popup blocking settings are applied.

At block 206, the user identifies information of interest. This may be information the user desires to incorporate into a project. Because the information may originate from any of a variety of sources, the information is not assigned to a particular data type. Moreover, the information is not assigned to a data type specific to the user's application. Generally, however, the information exists as either text or image data at the source.

Once the user identifies information of interest, the user may select a data category into which the user desires to assign the information. This takes place at block 208 and may include selecting a tab 314 on the project data panel 310. In the ensuing example, the user selects the “Facts” tab. Examples will be provided hereinafter for the “Notes” tab and the “Media” tab.

Selecting the Facts tab reveals existing project data for various data types within the Facts data category. These include, for example, birth place and date, death place and date, burial place and date, and the like. In addition, selecting the facts tab provides context for the acquisition of unstructured information from electronic resources.

At block 210, the user selects the information the user wishes to incorporate into the user's project. FIG. 3B depicts a closer view of what happens in the browser panel 308 when this happens. Upon selection of the data, the application launches (block 212) a pop-up menu 316 having data types into which the selected information may be assigned. The pop-up menu may have sub-menus 318. Using a pointing device, the user selects the data type to which the user desires to assign the unstructured information. Some embodiments provide an “other” data type. The selection takes place at block 214.

Upon selection of the data type at block 214, the application places the newly-assigned data into the information editing panel 312. This is depicted in FIG. 3C. In this example, the user has selected to assign the unstructured information displayed and selected in the browser panel 308 to the “birth date” data type.

In some embodiments, parsing routines may operate on the information within the context of the selected data type. For example, if the user selected a date data type, a parsing routine may further define portions of the information to day, year, and month.

Once the data appears in the editing panel 312, the user can edit it. This is represented by block 216. Once the user is satisfied with the arrangement and assignment of the unstructured data to a data type and category, then the user may merge the data into the user's project. This is represented by block 218.

FIG. 3D depicts selection of the “Notes” tab in the project data panel 310. Upon selection of unstructured information in the browser panel 308 with the Notes tab selected, the application launches an insert note button 320. Upon selection of the insert note button 320, the selected information is assigned as a note and placed into the editing panel 312. The information may be appended to existing note text or inserted into the middle of existing note text. The user may then edit the text and merge the note into the project.

FIG. 3E depicts selection of the “Media” tab in the project data panel 310. Upon selection of unstructured information in the browser panel 308 with the media tab selected, the application provides the user the option to assign the selected information as image or media data. A dashed border 322 identifies to the user the selected information. Using this feature, the user may archive full images, a particular web page, and/or the like. The user also may elect to store thumbnail versions of selected images.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. Accordingly, the above description should not be taken as limiting the scope of the invention, which is defined in the following claims.

What is claimed is:

1. A software application, comprising:
a window having at least first and second panels, wherein the first panel is programmed to provide access to Internet-based sources of information;
a user-operable selection tool programmed to select non-structured information from an Internet-based source of information presented in the first panel; and
a menu responsive to the selection tool programmed to:
appear upon the selection of non-structured information;
display a plurality of data types to which the selected non-structured information can be assigned; and
receive a user-selection of one of the plurality of data types to which the selected non-structured information is to be assigned;
wherein the second panel is programmed to, upon selection of one of the plurality of data types, display the selected non-structured data and indicate to which of the plurality of data types the selected information was assigned.

2. The software application of claim 1, further comprising a plurality of user-selectable data category tabs operable to determine the plurality of data types.

3. The software application of claim 2, wherein the software application comprises a genealogy investigation application, wherein one of the plurality of data category tabs comprises a facts tab, and wherein the plurality of data types comprise one or more selections from a group consisting of name, birth date, birth place, death date, death place, burial date, burial place, marriage date, marriage place, spouse's name, mother's name, father's name, and child's name.

4. The software application of claim 2, wherein the software application comprises a genealogy investigation application and wherein one of the plurality of data category tabs comprises a notes tab.

5. The software application of claim 2, wherein the software application comprises a genealogy investigation application and wherein one of the plurality of data category tabs comprises a media tab.

6. The software application of claim 1, wherein one of the data types comprises a date data type, and wherein the application is programmed to parse the selected non-structured information into a month, a day, and a year.

7. A computer-readable medium having stored thereon computer-executable instructions for capturing unstructured information from an electronic source for incorporation into a project as a particular data type, the instructions comprising instructions for:
displaying information from an electronic source;
receiving a user's selection of at least a portion of the information;
in response to the user's selection, displaying a menu of data types to which the information may be assigned;
receiving a user's selection of a data type; and
displaying the selected non-structured information and an indicator indicating to which of the plurality of data types the selected information was assigned.

8. The computer-readable medium of claim 7, wherein the instructions further comprise instructions for providing a plurality of user-selectable data category tabs operable to determine the data types.

9. The computer-readable medium of claim 8, wherein the instructions are comprised by a genealogy investigation application, wherein one of the plurality of data category tabs comprises a facts tab, and wherein the data types comprise one or more selections from a group consisting of name, birth date, birth place, death date, death place, burial date, burial place, marriage date, marriage place, spouse's name, mother's name, father's name, and child's name.

10. The computer-readable medium of claim 8, wherein the instructions are comprised by a genealogy investigation application, wherein one of the plurality of data category tabs comprises a notes tab.

11. The computer-readable medium of claim 8, wherein the instructions are comprised by a genealogy investigation application, wherein one of the plurality of data category tabs comprises a media tab.

12. The computer-readable medium of claim 7, wherein one of the data types comprises a date data type and wherein the instructions further comprise instructions for parsing the selected non-structured information into a month, a day, and a year.

13. A method of capturing unstructured information from an electronic source for incorporation into a project as a particular data type, the method comprising:
displaying information from an electronic source;
receiving a user's selection of at least a portion of the information;
in response to the user's selection, displaying a menu of data types to which the information may be assigned;
receiving a user's selection of a data type; and
displaying the selected non-structured information and an indicator indicating to which of the plurality of data types the selected information was assigned.

14. The method of claim 13, further comprising providing a plurality of user-selectable data category tabs operable to determine the data types.

15. The method of claim 14, wherein one of the plurality of data category tabs comprises a facts tab, and wherein the data types comprise one or more selections from a group consisting of name, birth date, birth place, death date, death place, burial date, burial place, marriage date, marriage place, spouse's name, mother's name, father's name, and child's name.

16. The method of claim 14, wherein one of the plurality of data category tabs comprises a notes tab.

17. The method of claim 14, wherein one of the plurality of data category tabs comprises a media tab.

18. The method of claim 14, wherein one of the data types comprises a date data type the method further comprising parsing the selected non-structured information into a month, a day, and a year.
